(19) United States
(12) Patent Application Publication
(10) Pub. No.: US 2006/0236502 A1
(43) Pub. Date: Oct. 26, 2006

(54) Door panel retaining device

(76) Inventor: Hsien-Chung Chiang, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/063,369

(22) Filed: Feb. 22, 2005

(51) Int. Cl. E05F 5/02

(52) U.S. Cl. 16/82

(57) ABSTRACT

A door panel retaining device includes a control knob for attaching to a door panel, one or more magnetically attractive members attached to the control knob, and another magnetically attractive member for attaching to the wall member and for acting with the magnetically attractive member of the control knob, and thus for attracting the control knob and the door panel to the wall member at an opening position. The door panel retaining device may be attached to the control knob of the door panel that is elevated and spaced away from the ground, to prevent the door panel retaining device from being wetted and rusted and damaged after use.

### BACKGROUND OF THE INVENTION

1. Field of the Invention

The present invention relates to a door panel retaining device, and more particularly to a door panel retaining device for retaining a door panel to a wall member at an opening position, to prevent the door panel from being disengaged from the wall member to a closed position inadvertently.

2. Description of the Prior Art

Typical door panel retaining devices have been developed for retaining a door panel to a wall member at an opening position, and for preventing the door panel from being disengaged from the wall member to a closed position inadvertently.

For example, as shown in FIG. 7, illustrated is one of the typical door panel retaining devices provided for retaining a door panel 10 to a wall member 11 at an opening position, and for preventing the door panel 10 from being disengaged from the wall member 11 to a closed position inadvertently.

Normally, the door panel 10 may include a lock or control device 20 to control the door panel 10, and having an inner control knob 21 and an outer control knob 22 for controlling or opening and closing the door panel 10 relative to the wall member 11.

The typical door panel retaining device comprises two magnet members or magnetically attractive members 12, 13 attached to the door panel 10 and the wall member 11 respectively, for acting or attracting with each other, and for retaining the door panel 10 to the wall member 11.

However, the magnet members or magnetically attractive members 12, 13 are normally attached to the bottom portions of the door panel 10 and the wall member 11 respectively, and will be easily wetted and rusted and damaged after use, particularly when the magnet members or magnetically attractive members 12, 13 are attached to the door panel 10 and the wall member 11 in bathrooms, washrooms, lavatories, or the like.

In addition, the magnet members or magnetically attractive members 12, 13 that are attached to the bottom portions of the door panel 10 and the wall member 11 may have a good chance to be kicked by users or may stumble people inadvertently, and thus may have a good chance to be easily damaged.

Furthermore, the magnet members or magnetically attractive members 12, 13 of the typical door panel retaining devices are two different or separate members that are required to be secured or attached to the door panel 10 and the wall member 11 respectively by the users themselves.

The present invention has arisen to mitigate and/or obviate the afore-described disadvantages of the conventional door panel retaining devices.

### SUMMARY OF THE INVENTION

The primary objective of the present invention is to provide a door panel retaining device for retaining a door panel to a wall member at an opening position, to prevent the door panel from being disengaged from the wall member to a closed position inadvertently.

The other objective of the present invention is to provide a door panel retaining device for attaching to a control knob of the door panel that is elevated and spaced away from the ground, for preventing the door panel retaining device from being wetted and rusted and damaged after use.

The further objective of the present invention is to provide a door panel retaining device including one of the magnet members or magnetically attractive members attached to the control knob that is provided in the door panel, and the other magnet member or magnetically attractive member that is required to be attached to the wall member by the users themselves.

In accordance with one aspect of the invention, there is provided a door panel retaining device for retaining a door panel to a wall member, the door panel retaining device comprising a control knob for attaching to the door panel, the control knob including an outer portion, at least one first magnetically attractive member attached to the outer portion of the control knob, a second magnetically attractive member for attaching to the wall member, the second magnetically attractive member being active with the first magnetically attractive member, for attracting the control knob and thus the door panel to the wall member, and thus for retaining the door panel to the wall member at an opening position, and to prevent the door panel from being disengaged from the wall member to a closed position inadvertently. The door panel retaining device may thus be attached to the control knob of the door panel that is elevated and spaced away from the ground, to prevent the door panel retaining device from being wetted and rusted and damaged after use.

The second magnetically attractive member includes an outer protective covering engaged thereon, to cover and to protect the second magnetically attractive member. The outer protective covering includes a peripheral skirt engaged onto the second magnetically attractive member, for engaging between the second magnetically attractive member and the wall member, and thus for allowing the outer protective covering to be solidly secured to the wall member and solidly secured between the second magnetically attractive member and the wall member.

The outer protective covering includes a slit formed therein, and the second magnetically attractive member includes at least one fastener for securing the second magnetically attractive member to the wall member, the slit of the outer protective covering is aligned with the fastener.

The control knob includes at least one cavity formed in the outer portion thereof, to receive the first magnetically attractive member therein. The control knob includes an outer cover attached to the outer portion thereof, to enclose the cavity thereof, and to solidly retain the first magnetically attractive member in the cavity thereof.

The control knob may further include an inner cover attached thereto, to enclose the cavity thereof, and to retain the first magnetically attractive member in the cavity thereof.

The control knob includes a bore formed therein, and a switch button received in the bore of the control knob and having a chamber formed therein, the first magnetically attractive member is received in the chamber of the switch button.

The switch button includes an outer portion having an outer cap attached thereto, to enclose the chamber thereof, and to retain the first magnetically attractive member in the chamber thereof. The switch button may further include an inner portion having a retaining ring attached thereto, to enclose the chamber thereof, and to retain the first magnetically attractive member in the chamber thereof.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a door panel retaining device in accordance with the present invention;

FIG. 2 is an enlarged partial exploded and cross sectional view of the door panel retaining device;

FIG. 3 is a partial exploded view illustrating a control knob of the door panel retaining device;

FIG. 4 is another partial exploded view illustrating an anchoring seat of the door panel retaining device;

FIG. 5 is an end view of the control knob of the door panel retaining device;

FIG. 6 is an end view of the anchoring seat of the door panel retaining device; and

FIG. 7 is a partial exploded view illustrating one of the typical door panel retaining devices for retaining a door panel to a wall member at an opening position.

### DETAILED DESCRIPTION OF THE PREFERRED EMBODIMENT

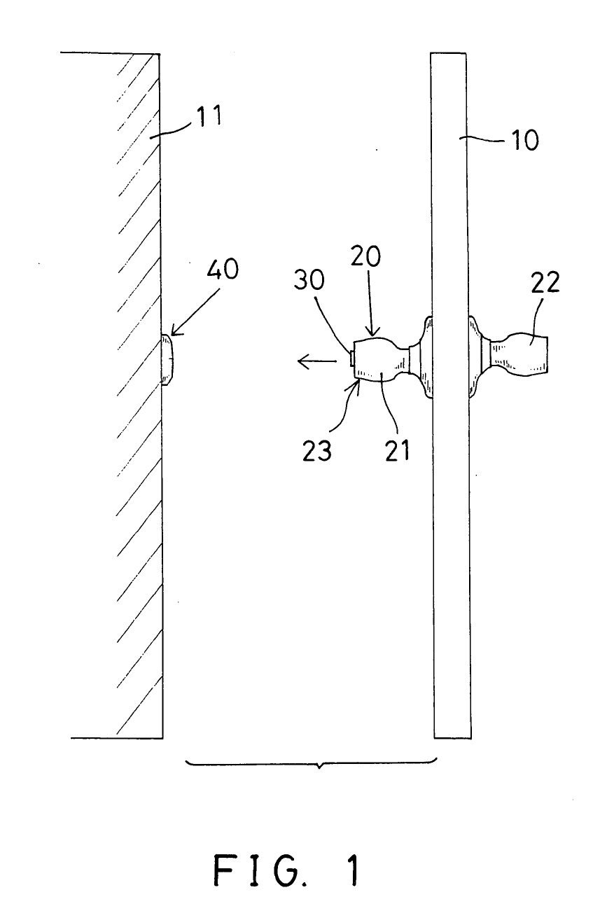

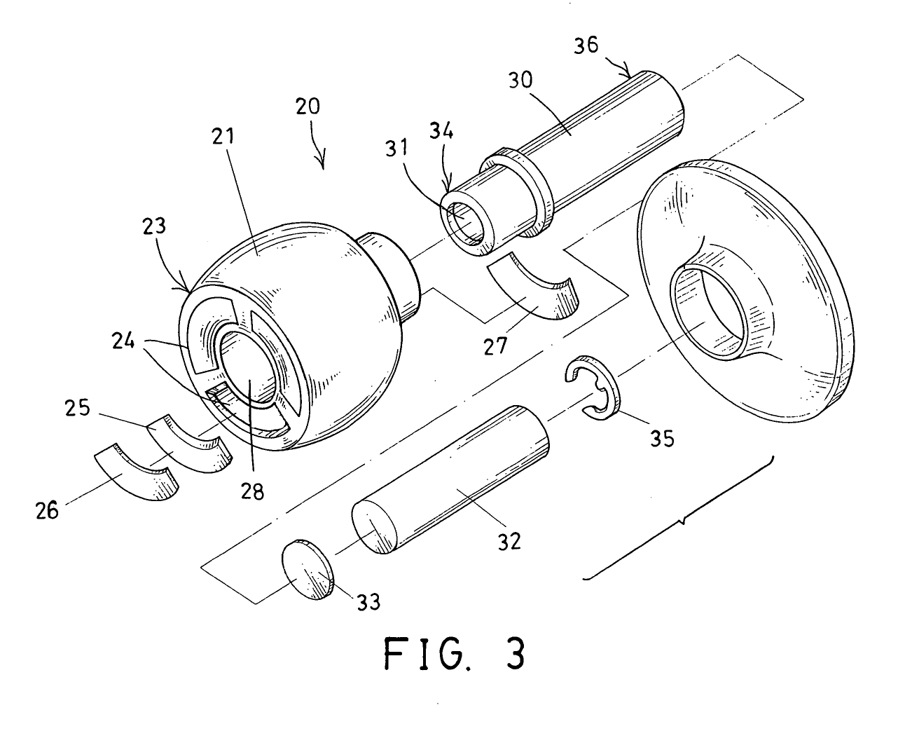

Referring to the drawings, and initially to FIGS. 1-3 and 5, a door panel retaining device 20 in accordance with the present invention also comprises an inner control knob 21 and an outer control knob 22 attached to the door panel 10, for controlling or opening and closing the door panel 10 relative to the wall member 11. The outer or inner control knob 21 includes a front or outer portion 23 having one or more cavities 24 formed therein, each for receiving a magnet member or magnetically attractive member 25 therein.

One or more outer covers 26 may be attached to the outer portion 23 of the control knob 21, and/or one or more inner covers 27 may be attached to the inner portion of the control knob 21, to enclose the cavities 24 of the control knob 21, and/or to retain or secure the magnetically attractive members 25 within the cavities 24 of the control knob 21 respectively. It is preferable that the outer covers 26 are made of transparent or semi-transparent materials, to allow the magnetically attractive members 25 to be seen through the transparent or semi-transparent outer covers 26. The control knob 21 includes a bore 28 formed therein for slidably receiving a control or switch button 30 therein.

The switch button 30 includes a chamber 31 formed therein for receiving a magnet member or magnetically attractive member 32 therein, and may further include an outer caps 33 attached to the outer portion 34 thereof and/or a retaining ring 35 attached to the inner portion 36 thereof, to enclose the chamber 31 of the switch button 30, and/or to retain or secure the magnetically attractive member 32 within the chamber 31 of the switch button 30. It is also preferable that the outer cap 33 is made of transparent or semi-transparent materials, to allow the magnetically attractive member 32 to be seen through the transparent or semi-transparent outer cap 33.

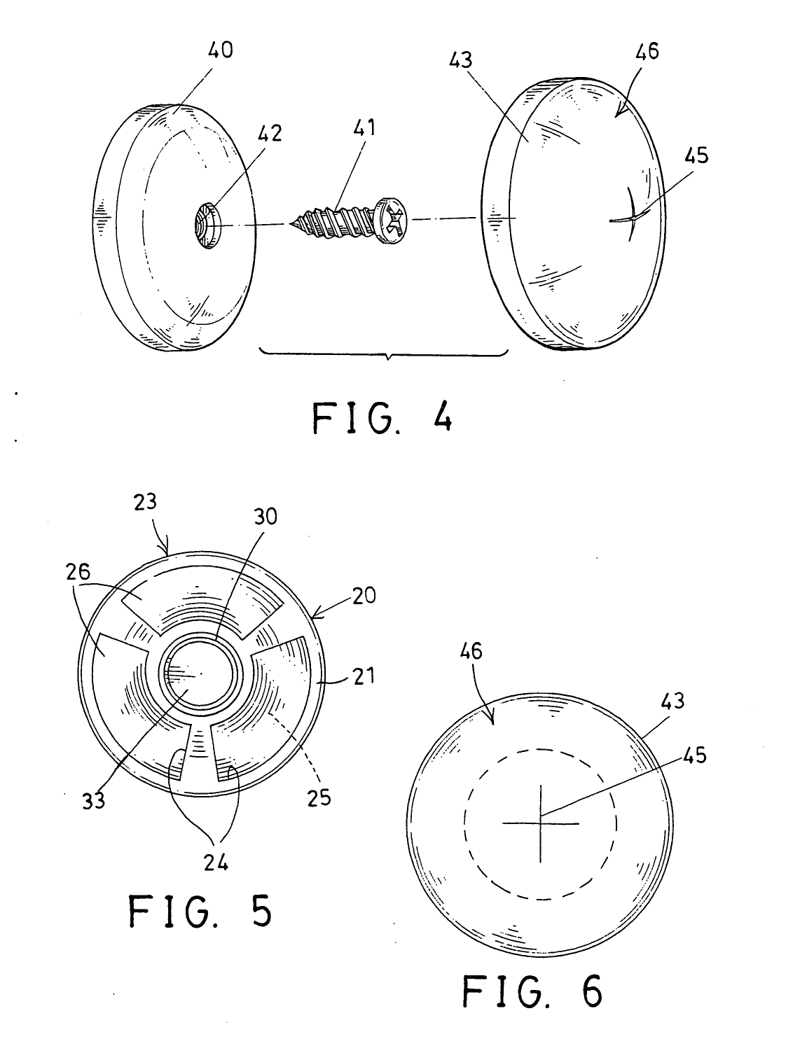

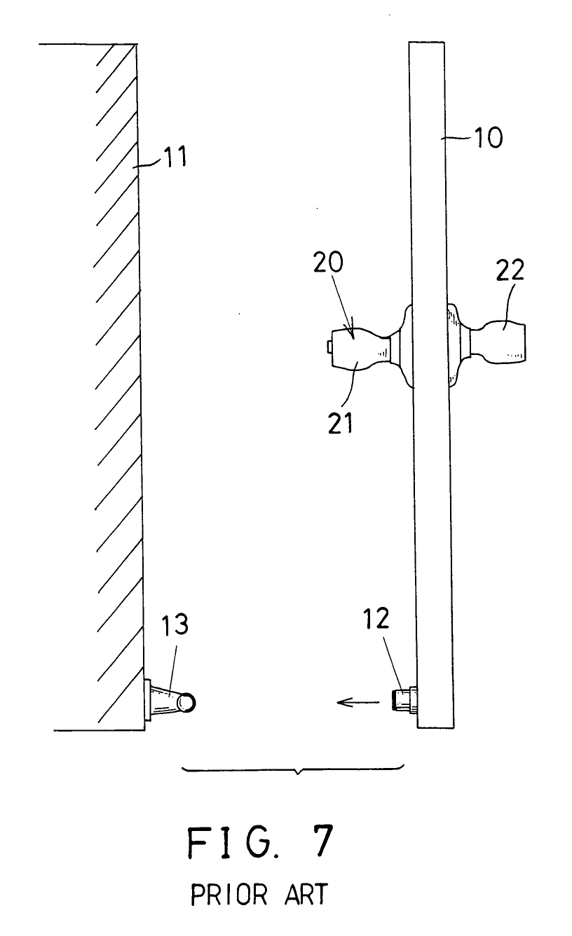

As shown in FIGS. 1-2, 4, and 6, the door panel retaining device 20 further includes another magnet member or magnetically attractive member 40 for attaching or securing to the wall member 11 with such as one or more fasteners 41. For example, the magnetically attractive member 40 includes one or more orifices 42 formed therein for receiving the fasteners 41, and for allowing the fasteners 41 to secure the magnetically attractive member 40 to the wall member 11.

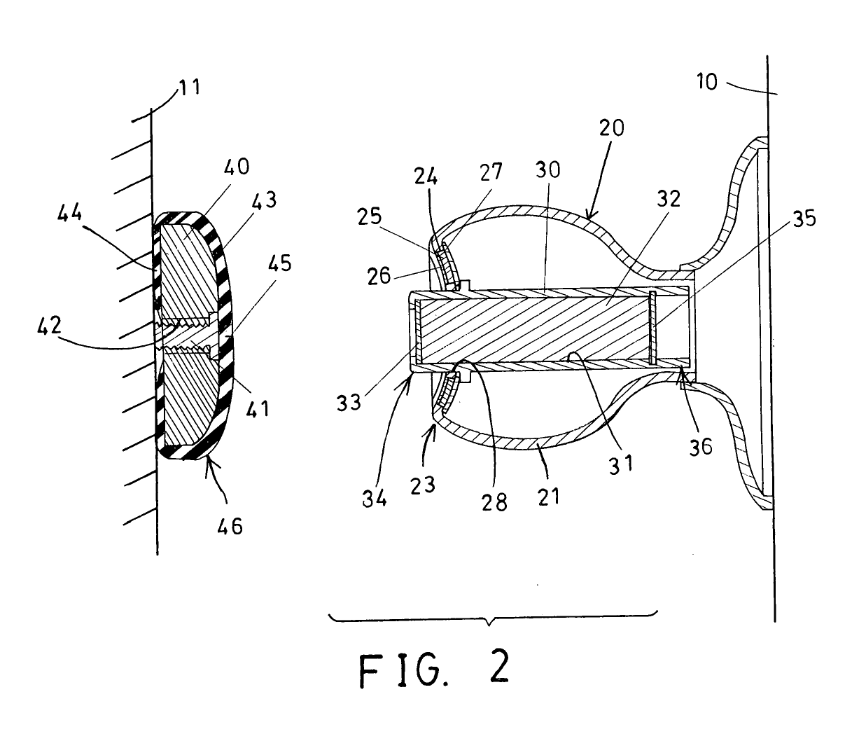

It is preferable that the door panel retaining device 20 further includes an outer protective sheath or covering 43 engaged onto the magnetically attractive member 40, for covering and protecting the magnetically attractive member 40, and for preventing the magnetically attractive member 40 from being wetted and rusted. The outer protective covering 43 preferably includes an inner peripheral skirt 44 engaged onto the magnetically attractive member 40, and engaged between the magnetically attractive member 40 and the wall member 11, best shown in FIG. 2, to allow the outer protective covering 43 to be solidly secured to the magnetically attractive member 40.

As shown in FIGS. 2, 4, 6, the outer protective covering 43 may further include a cross-shaped slit 45 formed in an outer portion 46 thereof, for aligning with the fastener 41, and for allowing the fastener 41 to secure the magnetically attractive member 40 to the wall member 11 after the outer protective covering 43 has been attached or engaged onto the magnetically attractive member 40; i.e., the driving device or tool (not shown) may be directly engaged through the slit 45 of the outer protective covering 43 to rotate or to drive the fastener 41 into the wall member 11.

It is to be noted that the magnetically attractive members 25 and/or the magnetically attractive members 32 may be provided and received in the control knob 21 and/or the switch button 30 respectively that are provided or attached on the door panel 10, such that the users are not required to attach or to secure the magnetically attractive members 25, 32 to the control knob 21 and/or the switch button 30 of the door panel 10. The users are only required to secure the magnetically attractive member 40 to the wall member 11 with the fastener 41.

The magnetically attractive members 25, 32, 40 may thus be elevated and spaced away from the ground, and may thus be prevented from being wetted and rusted and damaged after use. The outer protective covering 43 may be optionally engaged onto the magnetically attractive member 40, to cover and protect the magnetically attractive member 40, and to prevent the magnetically attractive member 40 from being wetted and rusted. The other magnetically attractive members 25, 32 may also be optionally covered and protected by the outer covers 26 and/or the outer cap 33, to prevent the magnetically attractive member 25, 32 from being wetted and rusted.

Accordingly, the door panel retaining device in accordance with the present invention may be provided for retaining the door panel to the wall member at an opening position, to prevent the door panel from being disengaged from the wall member to a closed position inadvertently, and may include the magnet members or magnetically attractive members attached to the control knob of the door panel and the wall member that are elevated and spaced away from the ground, for preventing the door panel retaining device from being wetted and rusted and damaged after use.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door panel retaining device for retaining a door panel to a wall member, said door panel retaining device comprising:
a control knob for attaching to the door panel, said control knob including an outer portion,
at least one first magnetically attractive member attached to said outer portion of said control knob,
a second magnetically attractive member for attaching to the wall member, said second magnetically attractive member being active with said at least one first magnetically attractive member, for attracting said control knob and thus the door panel to the wall member.

2. The door panel retaining device as claimed in claim 1, wherein said second magnetically attractive member includes an outer protective covering engaged thereon, to cover and to protect said second magnetically attractive member.

3. The door panel retaining device as claimed in claim 2, wherein said outer protective covering includes a slit formed therein, and said second magnetically attractive member includes at least one fastener for securing said second magnetically attractive member to the wall member, said slit of said outer protective covering is aligned with said at least one fastener.

4. The door panel retaining device as claimed in claim 2, wherein said outer protective covering includes a peripheral skirt engaged onto said second magnetically attractive member, for engaging between said second magnetically attractive member and the wall member.

5. The door panel retaining device as claimed in claim 1, wherein said control knob includes at least one cavity formed in said outer portion thereof, to receive said at least one first magnetically attractive member therein.

6. The door panel retaining device as claimed in claim 5, wherein said control knob includes an outer cover attached to said outer portion thereof, to enclose said at least one cavity thereof, and to retain said at least one first magnetically attractive member in said at least one cavity thereof.

7. The door panel retaining device as claimed in claim 5, wherein said control knob includes an inner cover to enclose said at least one cavity thereof, and to retain said at least one first magnetically attractive member in said at least one cavity thereof.

8. The door panel retaining device as claimed in claim 1, wherein said control knob includes a bore formed therein, and a switch button received in said bore of said control knob and having a chamber formed therein, said at least one first magnetically attractive member is received in said chamber of said switch button.

9. The door panel retaining device as claimed in claim 8, wherein said switch button includes an outer portion having an outer cap attached thereto, to enclose said chamber thereof, and to retain said at least one first magnetically attractive member in said chamber thereof.

10. The door panel retaining device as claimed in claim 8, wherein said switch button includes an inner portion having a retaining ring to retain said at least one first magnetically attractive member in said chamber thereof.
